(19) United States
(12) Patent Application Publication
(10) Pub. No.: US 2015/0042015 A1
(43) Pub. Date: Feb. 12, 2015

(54) RETAINING WALL BLOCK

(71) Applicants: Robert A. MacDonald, Plymouth, MN (US); David M. LaCroix, St. Paul, MN (US)

(72) Inventors: Robert A. MacDonald, Plymouth, MN (US); David M. LaCroix, St. Paul, MN (US)

(73) Assignee: KEYSTONE RETAINING WALL SYSTEMS LLC, West Chester, OH (US)

(21) Appl. No.: 14/521,858

(22) Filed: Oct. 23, 2014

Related U.S. Application Data
(63) Continuation of application No. 13/081,916, filed on Apr. 7, 2011.
Application No. 13/081,916 is a division of application No. 12/512,587, filed on Jul. 30, 2009, now abandoned.
Application No. 12/512,587 is a continuation of application No. 12/252,837, filed on Oct. 16, 2008, now abandoned.
(60) Provisional application No. 60/980,886, filed on Oct. 18, 2007.

(51) Int. Cl. B28B 3/02

(52) U.S. Cl. CPC B28B 3/02
USPC 264/333; 425/253

(57) ABSTRACT

A retaining wall block having a rear flange and a mold box and method of making the block. The mold box is configured with a mold cavity that includes a vertical flange forming cavity extending from the top of the mold box to the bottom of the mold box.

This application is a continuation of U.S. Ser. No. 13/081,916, filed Apr. 7, 2011, which is a continuation of U.S. Ser. No. 12/512,587, filed Jul. 30, 2009, which is a continuation of U.S. Ser. No. 12/252,837, filed Oct. 16, 2008, which claims the benefit of U.S. Provisional Application No. 60/980,886, filed Oct. 18, 2007, entitled “Retaining Wall Block”, the contents of each of which are hereby incorporated by reference herein.

### FIELD OF THE INVENTION

The present invention relates generally to retaining wall blocks and retaining walls constructed from such blocks. Additionally, the invention includes block molds and methods of manufacturing the blocks.

### BACKGROUND OF THE INVENTION

Retaining walls are used in various landscaping projects and are available in a wide variety of styles. Numerous methods and materials exist for the construction of retaining walls. Such methods include the use of natural stone, poured concrete, precast panels, masonry, and landscape timbers or railroad ties. In recent years, segmental concrete retaining wall units, which are dry stacked (i.e. built without the use of mortar), have become widely accepted in the construction of retaining walls. An example of such a unit is described in U.S. Pat. No. RE 34,314, which is issued to Forsberg (Forsberg '314). Such retaining wall units have gained popularity because they are mass produced and consequently, relatively inexpensive. They are structurally sound, easy and relatively inexpensive to install, and couple the durability of concrete with the attractiveness of various architectural finishes.

Typically, retaining walls are constructed with multiple courses of blocks. The various courses may be tied together or connected in some manner. For example, numerous block designs have used a sheer connector embodied in the blocks shape to align the blocks with a setback, or batter. A common form of such sheer connectors is a rear, downwardly projecting lip or flange. In forming a multi-course wall, the blocks are placed such that the flanges contact the upper back edge of the blocks located in the course below. As such, blocks having flanges are caused to become aligned with the blocks position below, while at the same time providing a degree of resistance against displacement of individual blocks by earth pressures. In walls formed using blocks of this type, the rear flanges of the blocks cause the wall to have a setback from course to course such that the wall slopes backward at an angle which is predetermined by the width of the flanges.

Retaining walls using blocks having a rear flange are well known in the art. For example, U.S. Pat. No. 3,323,363 (Schmitt) describes an early use of a retaining wall block with a rear flange. More recently, U.S. Pat. No. 5,294,216 (Sievert) describes a retaining wall constructed with retaining wall blocks having rear flanges. The Sievert patent also describes a mold and a method of making the retaining wall blocks in the mold. Specifically, Sievert discloses a mold and method whereby two blocks which are split later are simultaneously formed in facing pairs in the mold. The bottom surface of the blocks is formed at the top of the mold cavity and the flanges of the blocks are formed at the top of the mold by a compression head which has an instep which is shaped to form the flange of each block. There are several disadvantages with this process of forming retaining wall blocks. First, since mold boxes and production pallets come in typical sizes the orientation of the blocks with their top surfaces on the production pallets takes up considerable space and limits the number of blocks which can be formed on a pallet during a production cycle. Further, since the blocks are formed in pairs and are split apart along their front faces after the blocks have been cured the only texture which is imparted to the front faces of the blocks is the roughness which results from the splitting process.

Another method of forming a retaining wall block having a rear lip is described in U.S. Pat. No. 5,598,679 (Orton). Orton discloses a cast concrete block which is formed on its side. The cast concrete block is formed with at least two vertically oriented splitting grooves to enable it to be split into at least three construction blocks after it has been removed from the mold. Since the blocks are split along the front faces of the blocks the only texture which is imparted to the front faces of the blocks is the roughness which results from the splitting process.

Even more recently another method of forming a retaining wall block having a rear flange is described in U.S. Pat. No. 7,140,867 (Scherer). Scherer discloses a mold having a mold cavity wherein the rear surface of a block is formed adjacent a pallet which closes the bottom of the mold and a front face of the block is formed at the top of the mold cavity. This permits the front face of the block to be impressed with a pattern formed into the surface of a stripper shoe which is used to compress the moldable block material in the mold cavity. In this mold the rear flange of the block is formed in a flange-forming sub cavity which is defined between an undercut in one of the side walls of the mold and a portion of the flat surface of the pallet. Since the retaining wall blocks are oriented with their rear faces on the production pallet they take up less room and thus allow a greater number of retaining wall blocks to be produced on each pallet. Further, since the front faces of the blocks are oriented at the top of the mold box a desired texture or pattern can be imprinted on the front face with the stripper shoe. However, this mold box has several disadvantages. First, since the side surfaces of the retaining wall block which is formed converge towards the rear of the block the opposing side walls of the mold between which the converging sides of the block are formed are required to pivot or retract so that the bottom of the mold cavity opens to allow the retaining wall block to be discharged from the mold cavity. These moving side walls may become plugged with the moldable material or otherwise malfunction causing the mold to work improperly. Second, during the block manufacturing process if the flange-forming sub cavity is not completely filled with material or properly cleaned between mold cycles the flange may not be properly or completely formed on the block. Third, the orientation of the front face of the block at the open top of the mold box prohibits the blocks formed in the mold from being provided with a core. Blocks having cores are lighter and easier to handle and install than blocks without cores and are less costly to build.

### SUMMARY OF THE INVENTION

The present invention provides an improved retaining wall block having a textured front face and a rear flange extending from the rear surface of the block. In some embodiments the block includes a core or a plurality of cores extending between first and second side surfaces of the block. The core or cores may have any desired shape including round, oval, rectangular and square. The invention includes the mold in which the retaining wall block is formed and the method for making the retaining wall block in the mold. The invention also includes a retaining wall made with the block and the method of constructing the retaining wall with the blocks.

In one embodiment the invention is a retaining wall block for use in making a retaining wall. The block comprises opposed front and rear faces, opposed and substantially parallel top and bottom surfaces, opposed first and second side surfaces, the first side surface being orthogonal to the front and rear faces, the second side surface converging inwardly from the front to the rear face. The block includes a flange extending from the rear face of the block downward past the bottom surface of the block, the flange being configured such that the flanges of blocks in a first course of the retaining wall overlap the top surfaces of blocks in an adjacent lower course of the retaining wall to thereby provide a connection between the courses of blocks and setback between the courses of blocks in the retaining wall. The block may include a core extending between the first and second side surfaces, the core being substantially parallel to the front and rear faces. The front face may be imparted with a three dimensional surface texture or pattern and the core may comprise a plurality of cores. The core may have a shape selected from round, oval, rectangular, and square. The second side surface of the block may form an angle α with respect to the front face and wherein angle α is between about 5° to 20°, or wherein angle α is between about 7½° to 15°. Further, the retaining wall block might comprise a channel formed into a rear portion of the top surface and an upper portion of the rear face, the channel extending from the first side surface to the second side surface.

In another embodiment the invention is a mold assembly for use in producing retaining wall blocks having some or all of the features described above. The mold assembly may comprise a horizontal planar bottom member, a compression head, a mold box having a plurality of side walls that define a plurality of mold cavities having open mold cavity tops and open mold cavity bottoms, the horizontal planar member enclosing the open mold cavity bottoms of the plurality of mold cavities and the compression head enclosing the open mold cavity tops of the plurality of mold cavities during a block forming process. Each of the plurality of mold cavities may be shaped to form a single retaining wall block. Each of the plurality of mold cavities may be oriented such that the first side surface is formed at the bottom of the mold cavity and the second side surface is formed at the top of the mold cavity. One of the side walls of each of the plurality of mold cavities may be moveable from an inward block forming position to a retracted discharge position, the moveable sidewall having a three dimensional surface texture or pattern that imparts to the front face of the retaining wall block the three dimensional surface texture or pattern during the block forming process. The sidewalls of each of the plurality of mold cavities are shaped to form a vertically extending flange forming channel that provides the retaining wall block with a flange extending from the rear face downward past the bottom surface of the retaining wall block. The mold assembly further includes a core forming member which extends vertically into at least one of the plurality of mold cavities to provide the retaining wall block formed therein with a core extending from the first side surface to the second side surface. The core forming member may be configured to form a plurality of cores extending from the first side surface to the second side surface of the retaining wall block and the core or cores may have a shape selected from round, oval, rectangular and square. The compression head includes a lower surface which encloses the open mold cavity tops. The lower surface may be angled at an angle α with respect to horizontal such that the second side surface of the retaining wall block formed in each of the plurality of mold cavities during the block forming process forms angle α with respect to the front face of the retaining wall block, and wherein angle α is between about 5° to 20°, or between about 7½° to 15°. Further, the sidewalls of each of the plurality of mold cavities may be shaped to form a vertically extending ridge that provides the retaining wall block with a flange receiving channel formed into a rear portion of the top surface and an upper portion of the rear face of the retaining wall block.

In another embodiment the invention is a mold assembly for use in producing retaining wall blocks. The mold assembly may comprise a horizontal planar bottom member, a compression head, and a mold box having a plurality of side walls that define a plurality of mold cavities having open mold cavity tops and open mold cavity bottoms. The horizontal planar member encloses the open mold cavity bottoms of the plurality of mold cavities and the compression head encloses the open mold cavity tops of the plurality of mold cavities during a block forming process. Each of the plurality of mold cavities are shaped to form a single retaining wall block having features as described herein. Each of the plurality of mold cavities may be oriented such that the first side surface is formed at the bottom of the mold cavity and the second side surface is formed at the top of the mold cavity. One of the side walls of each of the plurality of mold cavities may be moveable from an inward block forming position to a retracted discharge position and the moveable sidewall may have a three dimensional surface texture or pattern that imparts to the front face of the retaining wall block the three dimensional surface texture or pattern during the block forming process. The sidewalls of each of the plurality of mold cavities are shaped to form a vertically extending flange forming channel that provides the retaining wall block with a flange extending from the rear face downward past the bottom surface of the retaining wall block. The compression head has a lower horizontal surface which encloses the open mold cavity top of at least one mold cavity. The lower surface may have a three dimensional surface texture or pattern that imparts to the second sidewall of the retaining wall block the three dimensional surface texture or pattern during the block forming process. Further, the sidewalls of each of the plurality of mold cavities may be shaped to form a vertically extending ridge that provides the retaining wall block with a flange receiving channel formed into a rear portion of the top surface and an upper portion of the rear face of the retaining wall block.

In a further embodiment the invention is a mold assembly for use in producing retaining wall blocks of a first type and retaining wall blocks of a second type. The assembly comprises a horizontal planar bottom member, a compression head, and a mold box having a plurality of side walls that define a plurality of mold cavities having open mold cavity tops and open mold cavity bottoms. At least one of the plurality of mold cavities may be configured to form the first type block and the remainder of the mold cavities may be configured to form the second type block. The horizontal planar member encloses the open mold cavity bottoms of the plurality of mold cavities and the compression head has one or more horizontal surfaces for enclosing the open mold cavity top of the at least one mold cavity configured to form the first type block and the compression head having one or more angled surfaces for enclosing the open mold cavity tops of the remainder of the plurality of mold cavities used to form the second type block during a block forming process. Each of the plurality of mold cavities is shaped to form a single retaining wall block having features similar to those described above. Each of the plurality of mold cavities may be oriented such that the first side surface is formed at the bottom of the mold cavity and the second side surface is formed at the top of the mold cavity. One of the side walls of each of the plurality of mold cavities may be moveable from an inward block forming position to a retracted discharge position. The moveable sidewall has a three dimensional surface texture or pattern that imparts to the front face of both types of the retaining wall block the three dimensional surface texture or pattern during the block forming process. The sidewalls of each of the plurality of mold cavities are shaped to form a vertically extending flange forming channel that provides the retaining wall block with a flange extending from the rear face downward past the bottom surface of the retaining wall block. The assembly may further include a core forming member which extends vertically into each of the remainder of the plurality of mold cavities used to form the second type block to provide the second type block formed therein with a core extending from the first side surface to the second side surface. The horizontal surface of the compression head may have a three dimensional texture or pattern which imparts to the second side surface of the first type of block the three dimensional texture or pattern during the block forming process.

In another embodiment the invention is a method of making a plurality of retaining wall blocks comprising providing a mold assembly including a pallet, a compression head, a mold box having a plurality of side walls that define a plurality of mold cavities having open mold cavity tops and open mold cavity bottoms, and a core forming member that extends vertically into at least one of the plurality of mold cavities from the mold cavity top to the mold cavity bottom. Each of the plurality of mold cavities are shaped to form a single retaining wall block having the feature as described herein. Each of the plurality of mold cavities may be oriented such that the first side surface is formed at the bottom of the mold cavity and the second side surface is formed at the top of the mold cavity. The sidewalls of each of the plurality of mold cavities are shaped to form a vertically extending flange forming channel. One of the side walls of each of the plurality of mold cavities may be moveable from an inward block forming position to a retracted discharge position, the moveable side walls having a three dimensional surface texture or pattern. The method includes positioning the pallet beneath the mold box to enclose the mold cavity bottoms; filling the mold cavities with dry cast concrete while the moveable side walls are in the inward block forming position; lowering the compression head to enclose the open mold cavity tops and compress the dry cast concrete within the plurality of mold cavities; moving the moveable side walls from the inward block forming position to the retracted discharge position; and lowering the pallet and the compression head to strip the dry cast concrete from the plurality of mold cavities. The core forming member may be configured to form a plurality of cores extending from the first side surface to the second side surface of the retaining wall block. Further, the core forming member may be configured to form a core having a shape selected from round, oval, rectangular and square. The compression head includes a lower surface which encloses the open mold cavity tops. The lower surface may be angled at an angle α with respect to horizontal such that the second side surface of the retaining wall block formed in each of the plurality of mold cavities during the block forming process forms angle α with respect to the front face of the retaining wall block, and wherein angle α is between about 5° to 20°, or between about 7½° to 15°. The side walls of each of the plurality of mold cavities may be shaped to form a vertically extending ridge that provides the retaining wall block with a flange receiving channel formed into a rear portion of the top surface and an upper portion of the rear face of the retaining wall block.

In a further embodiment the invention is a retaining wall comprising a plurality of courses of retaining wall blocks having the features described above. The retaining wall includes a first upper course and a second lower course of blocks. The blocks in the first upper course are positioned over adjacent blocks in the second lower course such that the flanges of the blocks in the first course extend downward behind the top surface of blocks in the second course to engage the rear face of blocks in the first course and to provide a setback from the second course to the first course equal to a depth of the flanges and such that the cores of the blocks in each course align horizontally, the cores being sized to accept a horizontal reinforcement member.

In another embodiment the invention is a method of constructing a retaining wall using the blocks described above. The wall thus built may include blocks of the first type and/or blocks of the second type.

In another embodiment the invention is a method of stacking blocks with the features described above on a shipping pallet. The blocks are stacked on the pallet in multiple layers in the same orientation they are when removed from the mold. In this orientation the layer of blocks on the shipping pallet is formed with an angled side of the blocks facing up to create an upper surface layer that is not level. The method includes placing a wedge or triangular shaped insert over the first and succeeding layers of blocks in order to form a flat surface on which each succeeding layer of blocks may be placed.

### BRIEF DESCRIPTION OF THE DRAWINGS

FIG. 1 is a perspective view of one embodiment of the retaining wall block in accordance with the invention.

FIG. 2 is another perspective view of the block of FIG. 1 oriented on one of its side surfaces in a position similar to the position in which the block is formed in the mold.

FIG. 3A is a plan view of an embodiment of the mold box in accordance with the present invention. FIG. 3B is a plan view of an alternate embodiment of the mold box in accordance with the present invention.

FIG. 4A is an end view of the retaining wall blocks formed in the mold of FIG. 3A sitting on a pallet after removal from the mold. FIG. 4B is an end view of a compression head of a stripper shoe for use with the present invention. FIG. 4C is an end view of a core bar for use with the present invention.

FIG. 5A is another embodiment of a mold box in accordance with the present invention. FIG. 5B is another alternate embodiment of a mold box in accordance with the present invention.

FIG. 6 is an end view of retaining wall blocks formed in the mold box of FIG. 5A sitting on the pallet after they have been removed from the mold box.

FIG. 7 shows retaining wall blocks of the present invention stacked on a shipping pallet.

FIG. 8 shows a portion of a concave wall formed with retaining wall blocks of the present invention.

FIG. 9 shows a portion of a convex wall formed with retaining wall blocks of the present invention.

FIG. 10 is a retaining wall having both straight and curved portions formed with retaining wall blocks of the present invention.

FIG. 11 is a partial cross-sectional side view of a retaining wall formed with retaining wall blocks of a further embodiment of the present invention and illustrating various options for forming cores in the blocks.

FIG. 12 is a perspective view of a portion of a retaining wall formed with blocks of the present invention including a rectangular corner block having a textured surface formed on both the front face of the block and one of the adjacent side walls.

### DETAILED DESCRIPTION OF PREFERRED EMBODIMENTS

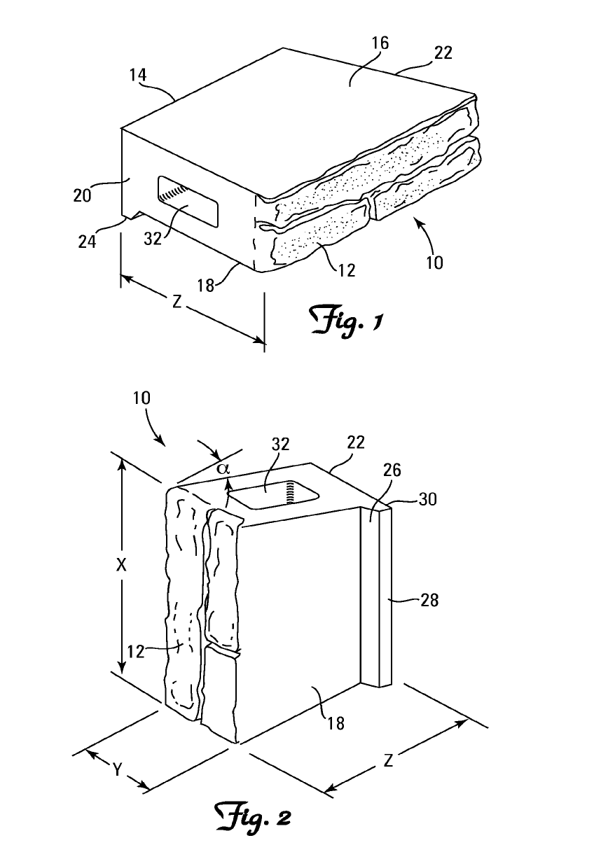

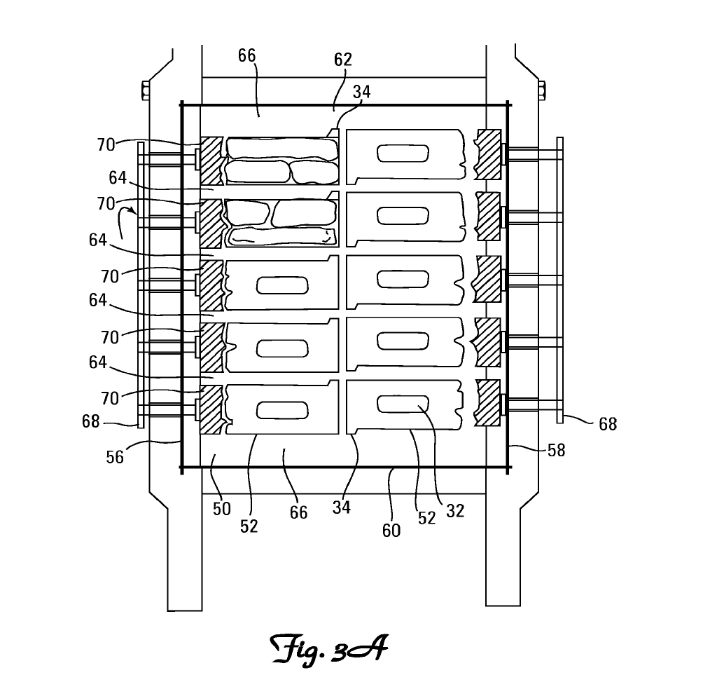

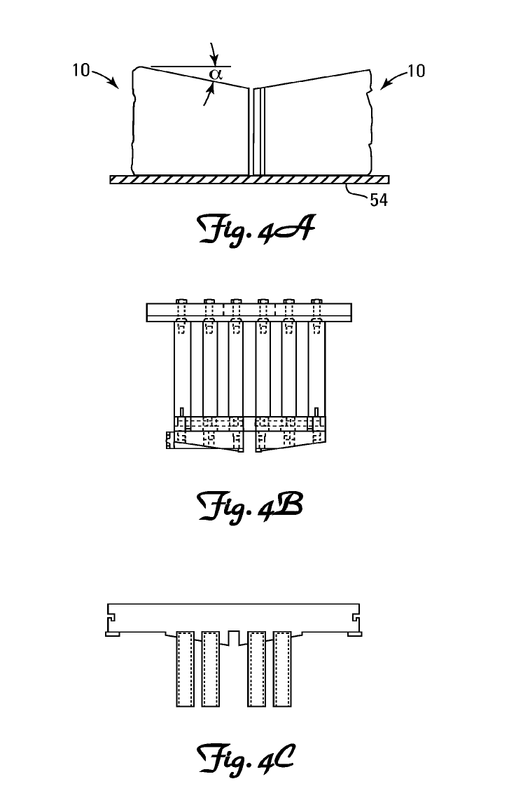

A retaining wall block 10 according to the present invention is shown in perspective in FIGS. 1 and 2. Block 10 comprises a block body defined by opposed front and rear faces 12 and 14, respectively. The front and rear faces are substantially parallel and are separated by a distance Z which comprises the depth of the block. The depth of the block is determined by the size of the mold in which the block is formed as will be described in more detail hereafter. Typically, the depth will be in the range of about 5 to 9 inches. The block body includes opposed top and bottom surfaces 16 and 18, respectively. The top and bottom surfaces are substantially parallel and separated by a distance Y which comprises the thickness or height of the block. The block thickness is determined by the size of the mold and for a typical block may be 4 inches. The block body includes opposed first and second side surfaces 20 and 22, respectively. The first and second side surfaces are not parallel to each other. Rather, first side surface 20 is orthogonal to both the front and rear faces of the block. Second side surface 22 is angled to converge inwardly from the front face of the block to the rear face. Although the first side surface 20 is shown on the left side of the block 10 of FIG. 1 it should be understood that the side surfaces could be switched so that the angled side was on the left and the orthogonal side on the right. Second side surface 22 forms an angle alpha (α) with respect to the front surface of the block as seen in FIGS. 2 and 4. Preferably, angle α is in the range of about 5 to 20 degrees. More preferably, angle α is in the range of about 7½ to 15 degrees. The distance between the first and second side surfaces at the front face 12 of the block defines the width X of the block. The width of the block depends upon the size of the mold in which the block is formed and may be, for example, 8 inches or 12 inches.

Block 10 includes a flange 24 extending from the rear face 14 downward past the bottom surface 18 of the block. The flange has a front surface 26, a lower surface 28 and a back surface 30 that extends continuously from the rear face 14 of the block. The purpose of the rear flange is to provide both a desired amount of setback between courses of blocks in a retaining wall and a means of securing one course of blocks above a lower course of blocks in a retaining wall to help prevent block displacement due to pressures from the earth or backfill behind the wall. As such, the size of the flange may be selected to accomplish these desired objectives. For example, the back surface 30 of the flange may extend ½ inch below the bottom surface 18 of the block, the lower surface 28 of the flange may have a depth of approximately ½ inch and the front surface 26 of the flange may be parallel to the back surface 30 or may be angled such that a distance between the lower surface 28 and the bottom surface 18 of the block is approximately ¾inch.

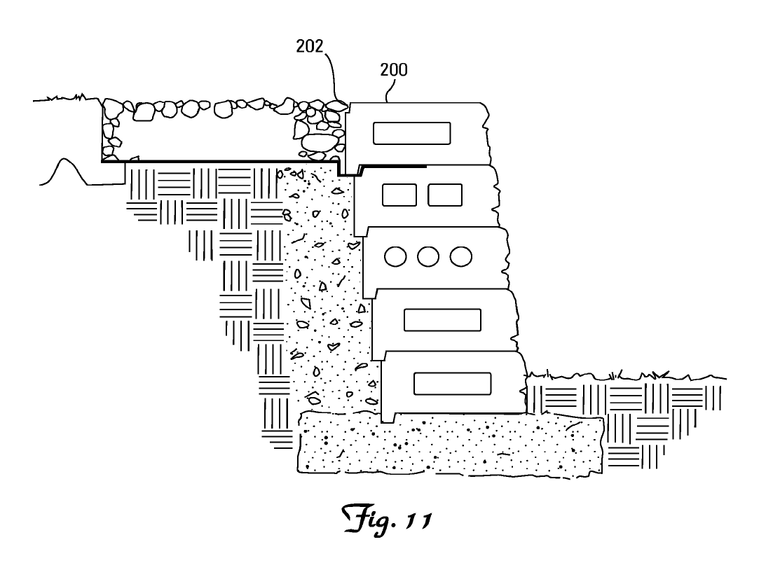

In some embodiments of the invention the block body may also be provided with a core 32. Core 32 may be of a desired cross-sectional shape which may include round, oval, rectangular and square and may comprise one or more voids or cavities in the block as described in more detail in connection with FIG. 11.

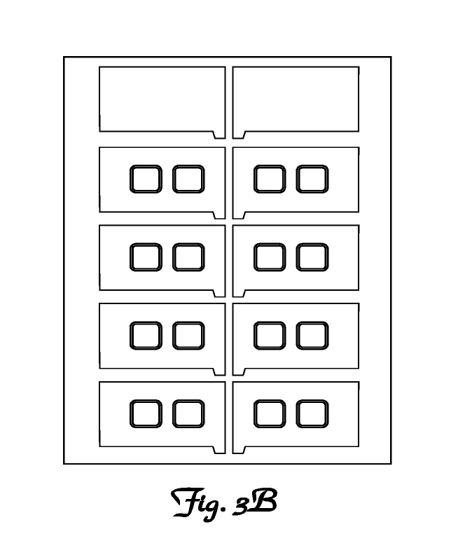

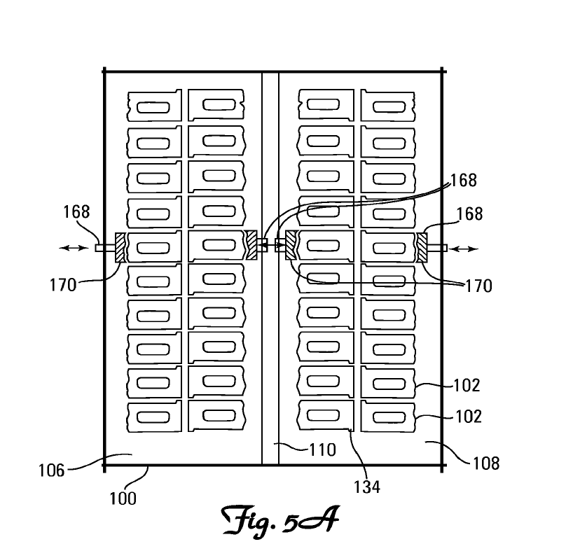

In accordance with the present invention retaining wall blocks 10 are formed in mold boxes described in FIGS. 3A and 5A having multiple mold cavities and where the blocks are formed with the first side surface 20 resting on the production pallet and the second side surface 22 oriented at the top of the open mold cavity. This orientation of the blocks takes up less space on the production pallet than if the blocks were oriented in a mold with their top surface on the production pallet such as in the Sievert '216 patent. Thus, the number of mold cavities in the mold box can be increased so that a greater number of blocks can be made in a production cycle on a production pallet.

FIG. 3A is a plan view of a mold box 50. Mold box 50 includes ten mold cavities 52 in which eight retaining wall blocks 10 and two corner blocks 72 may be formed in a production cycle on a production pallet as described in more detail hereafter. FIG. 4A is an end view of blocks 10 resting on a production pallet 54 after the blocks have been discharged from mold box 50. Blocks of different sizes can be made in mold box 50. By way of example, the blocks formed in mold box 50 may have a width of 8 or 12 inches depending on the height of the mold cavities above the production pallet, a height of 4 inches, and a depth of 7 inches. Mold box 50 is configured and sized for use with a typical production pallet which may have a size of 18 inches by 26 inches.

Mold box 50 generally includes opposing first and second side frame walls 56 and 58 and opposing first and second end frame walls 60 and 62. The mold cavities 52 are formed by division liners 64 and end liners 66 which are fixedly or removably attached to frame walls 56, 58, 60 and 62 of the mold box in known manner. The liners 64 and 66 form side walls which, along with moveable liner 70 described hereafter, define a plurality of mold cavities having open mold cavity tops and open mold cavity bottoms. Each of the mold cavities have a vertical flange forming channel 34 formed by the side walls extending from the top of the mold box to the bottom and which form a flange 24 on each block. Blocks 10 may be formed with cores. The optional cores are formed with core bars which span the side frame walls and are used to support core forms which create vertical voids in the blocks produced in the mold cavities. This is done in accordance with known techniques and an end view of a core bar and core forms for forming two cores in each block is shown in FIG. 4C. It will be understood that this core by is shown by way of example and that other core bars with different core form shapes and arrangements may be used as desired. The core forms may be slightly tapered inwardly from the top of the mold to the bottom to insure that the blocks may be discharged from the mold cavity without difficulty at the end of the production cycle.

Mold box 50 also includes moveable side liner mechanisms 68 which are attached to impression face liners 70. During the block production cycle the movable side liner mechanisms are positioned in a first inward or block forming position when the mold cavities are filled with moldable material. The impression face liners 70 may be created with any desired three dimensional texture or pattern and impart to the front face 12 of the retaining wall blocks any desired three dimensional texture or pattern when in this first position. When the blocks have been formed and are ready to be discharged from the mold cavities moveable side liner mechanisms 68 are moved to a second retracted or discharge position shown generally on the right side of FIG. 3A. The moveable side liner mechanisms may comprise rod and piston type mechanisms, worm gear mechanisms, hinged or pivoting walls or any other arrangement known to those of skill in the art to cause the face impression liners 70 to move between the first and second positions. In this retracted position the impression face liners are spaced from the front face of the blocks far enough to allow the blocks to be discharged from the mold cavities without interference from the face liners. FIG. 3B shows an alternate embodiment of the mold box of FIG. 3A which does not include moveable side liner mechanisms. It should be understood that the mold box is not limiting and variations and alternate embodiments may be used as desired. It should be further understood that a plurality, but not all, of the mold cavities may have moveable side liner mechanisms. For example, the mold cavities on one side of mold boxes 50 or 100 may have moveable liner mechanisms and the mold cavities on the other side may have stationary side walls.

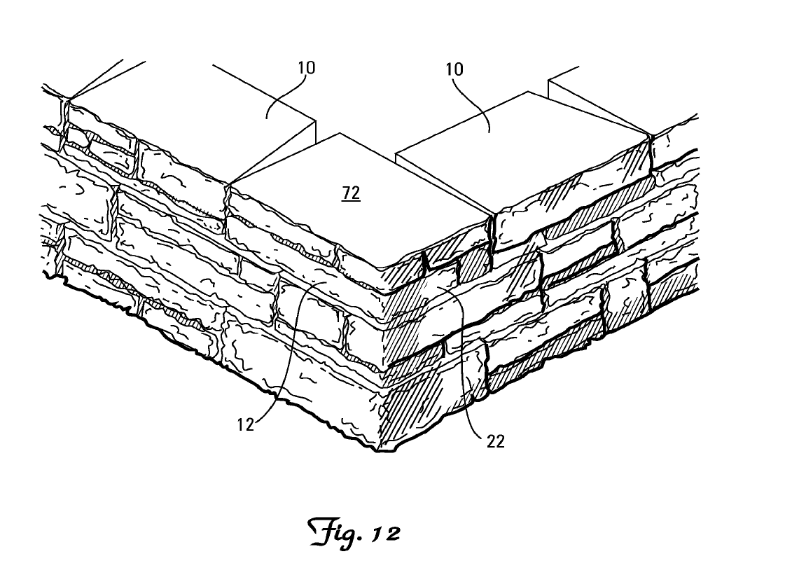

A stripper shoe compression head such as shown in end view in FIG. 4B is used to compact the material in the mold cavities and to aid in discharging the blocks from the mold cavities when the production cycle is complete. Typically, a lower surface of the compression head which contacts the block at the top of the open mold cavity lies in a generally horizontal plane. This lower surface is typically discontinuous and shaped so that it can be extended into the mold cavities and avoid core bars and core forming elements and the like. The lower surface of the compression head may have a three dimensional texture or pattern to impart such three dimensional texture or pattern to the portion of the block at the open top of the mold cavity. In accordance with the present invention the surface of the compression head which contacts the second side surface of the retaining wall block at the top of the open mold cavity may be either horizontal to create a first type block which may be a generally rectangular corner block 72 as shown and described in connection with FIG. 12 or may be angled to create a second type block, the angled surface imparting to the second side surface the angle α as shown in FIGS. 2 and 4. As shown in the two mold cavities in the upper left corner of FIG. 3A the surface of the compression head which contacts the moldable material at the open top of the mold cavity forming the second side surface of the block may be textured or patterned to impart on the second side surface any desired three dimensional texture or pattern. This is especially useful in forming a rectangular corner block where both the front face and an adjacent side are exposed. The ability to texture or pattern both the front face and the adjacent side is esthetically desirable. Such a block may be used along with the angled blocks to form a retaining wall having a 90 degree corner as shown in FIG. 12. Rectangular corner block 72 shown in FIG. 12 has a front face 12 having a pattern imparted by impression face liner 70 and a second side surface 22 adjacent to front face 12 having a pattern imparted by the compression head. A mold box such as shown in FIG. 3A having mold cavities which are configured to form both corner blocks and regular wall blocks with an angled side surface is useful since it requires only one mold box and one mold cycle to produce both types of blocks. It should be understood, however, that mold box 50 may be configured so that corner blocks 72 are formed in one or more mold cavities at any desired location of the mold box. Further, it is possible to configure the mold box so that all of the mold cavities are used to form corner blocks or that all of the mold cavities are used to form regular wall blocks or any desired combination thereof. The illustration of the corner blocks being formed in the two mold cavities in the upper left of FIG. 3A is merely one example of how the mold box may be configured.

FIG. 5A shows a mold box which is larger than mold box 50 and which has 40 mold cavities. Such a mold box is designed for use on a larger production pallet which may have a size of 44 inches by 55 inches. Except for the size the general features of mold box 100 are similar to those of mold box 50. Specifically, mold box 100 is configured and sized for use with a large production pallet which may have a size of 44 inches by 55 inches.

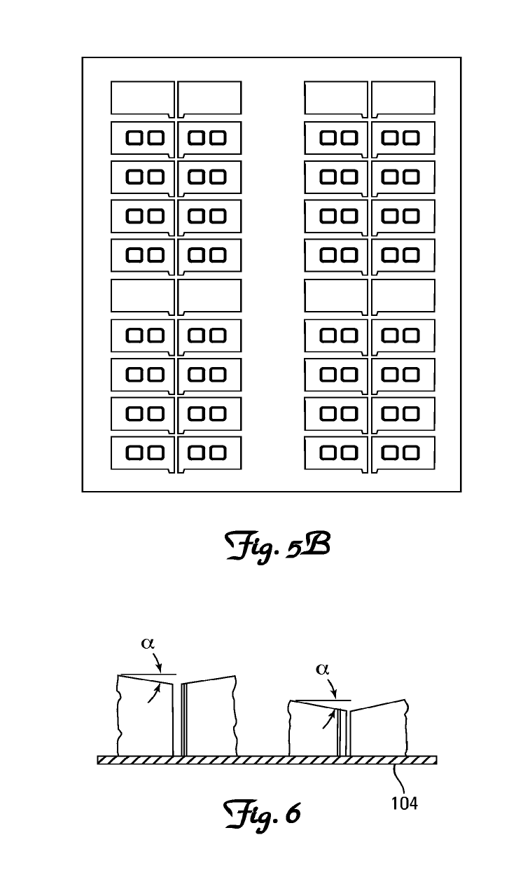

Mold box 100 generally includes first and second mold sections 106 and 108. Each mold section 106, 108 has two rows of mold cavities with 10 mold cavities per row. The mold cavities are defined in each mold section between side frame walls, and end frame walls and division liners in similar manner to mold box 50. As shown in FIG. 6 the mold sections can be of different size to create blocks having a width of 12 inches as shown to the left or 8 inches as shown to the right. Typically, all of the blocks formed in a mold box will be of the same width. Each of the mold cavities have a vertical flange forming channel 134 extending from the top of the mold box to the bottom and which form a flange 24 on each block. The optional cores are formed with core bars which span the side frame walls and are used to support core forms which create vertical voids in the blocks produced in the mold cavities. This is done in accordance with known techniques and the core bars and core forms are not shown in the drawing. The cores may be slightly tapered inwardly from the top of the mold to the bottom to insure that the blocks may be discharged from the mold cavity without difficulty at the end of the production cycle.

Each mold section of mold box 100 includes moveable side liner mechanisms 168 which are attached to impression face liners 170. Although only one side liner mechanism and face liner are shown for each row of mold cavities it should be understood that there may be one for each mold cavity. The side liner mechanisms closest to the interior of the mold are positioned in a channel 110 located between the mold sections. During the block production cycle the movable side liner mechanisms are positioned in a first inward or block forming position when the mold cavities are filled with moldable material. The impression face liners 170 may be created with any desired three dimensional texture or pattern and impart to the front face 12 of the retaining wall blocks any desired three dimensional texture or pattern when in this first position. When the blocks have been formed and are ready to be discharged from the mold cavities moveable side liner mechanisms 168 are moved to a second retracted or discharge position. In this retracted position the impression face liners are spaced from the front face of the blocks far enough to allow the blocks to be discharged from the mold cavities without interference from the face liners. FIG. 5B shows an alternate embodiment of the mold box of FIG. 5A which does not include movable side liner mechanisms. It should be understood that the mold box is not limiting and variations and alternate embodiments may be used as desired such as those described with respect to FIGS. 3A and 3B. For example, either blocks 10 and/or blocks 72 can be formed in any combination in the mold cavities of mold box 100. FIG. 6 is an end view of blocks 10 resting on a production pallet 104 after the blocks have been discharged from mold box 100.

The retaining wall blocks of the present invention are made according to a process which is similar regardless of whether mold box 50 or mold box 100 is used. A pallet is positioned beneath the mold to close the bottom of the mold cavity. Moldable material which may comprise dry cast concrete is then loaded from a hopper into the mold cavities through the open top of the cavity. The moldable material in the cavity is next compacted by vibrating the cavity at the same time that the material is compacted by lowering the compression head from above the open top of the mold cavity. The combination of the actions of vibration and compression insure that the moldable material completely fills the mold cavity including the vertical channel in the side wall of the mold cavity which forms the flange 24 of the blocks. When sufficient vibration and compaction have been applied to insure that there are no unfilled cavities or voids within the mold cavities the blocks are ready to be discharged from the mold cavity. Prior to such discharge the moveable side liner mechanisms are retracted. Both the compression head and the production pallet are then lowered to assist in stripping the block from the mold cavity. The compression head is then raised upwardly out of the mold cavity and after any appropriate cleaning the production cycle is ready to be repeated.

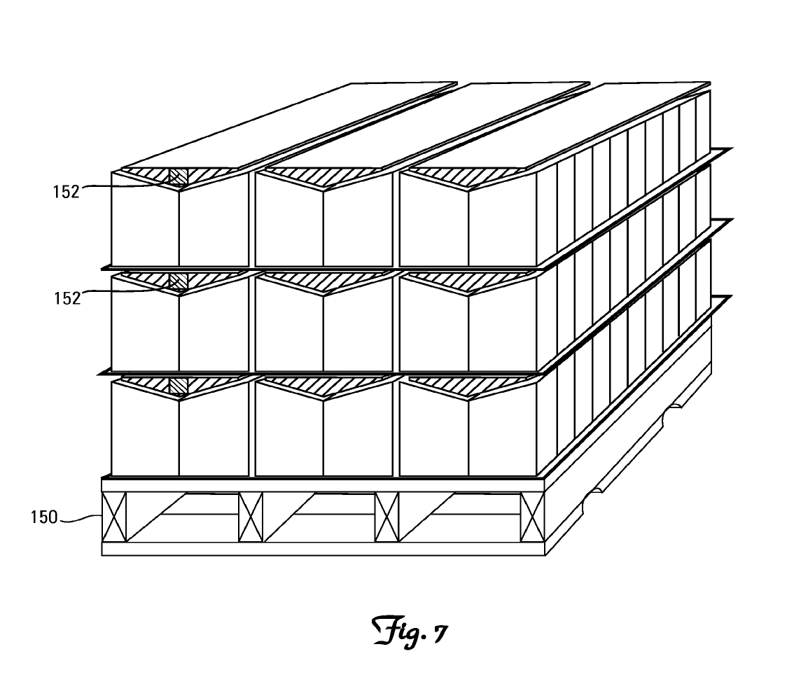

FIG. 7 shows multiple units of retaining wall blocks of the present invention stacked on a wooden shipping pallet 150. As can be seen multiple production cycles of the blocks can be removed from the production pallets on which they are formed in the orientation as depicted in FIG. 4 and stacked in multiple layers on shipping pallet 150. FIG. 7 shows three layers of blocks with 60 blocks per layer for a total of 180 blocks on the pallet. Since the blocks are placed on the shipping pallet with the angled second side up inserts 152 which may have a wedge or triangular shape are placed between layers in order to form a flat surface on which each succeeding layer may be placed. Inserts 152 may be made of wood, plastic, Styrofoam, cardboard or any other material which will resist deformation in this application.

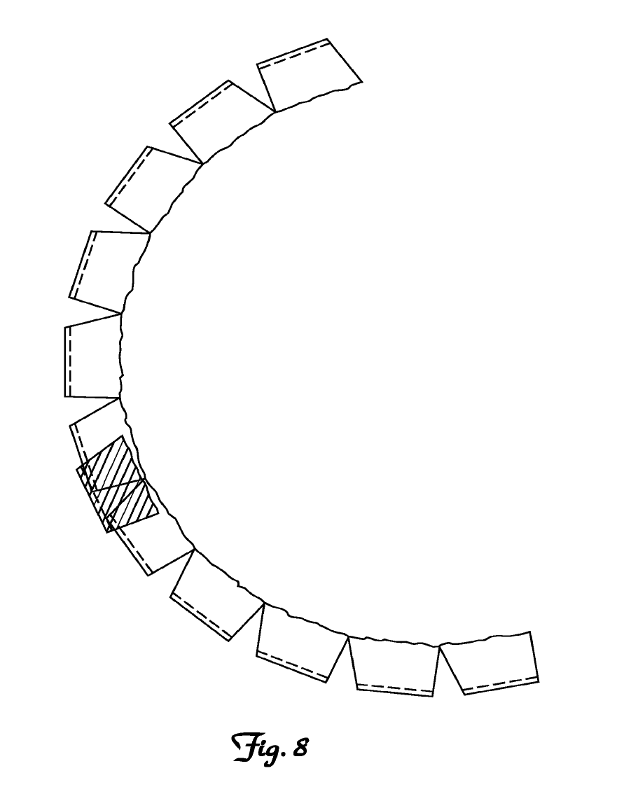

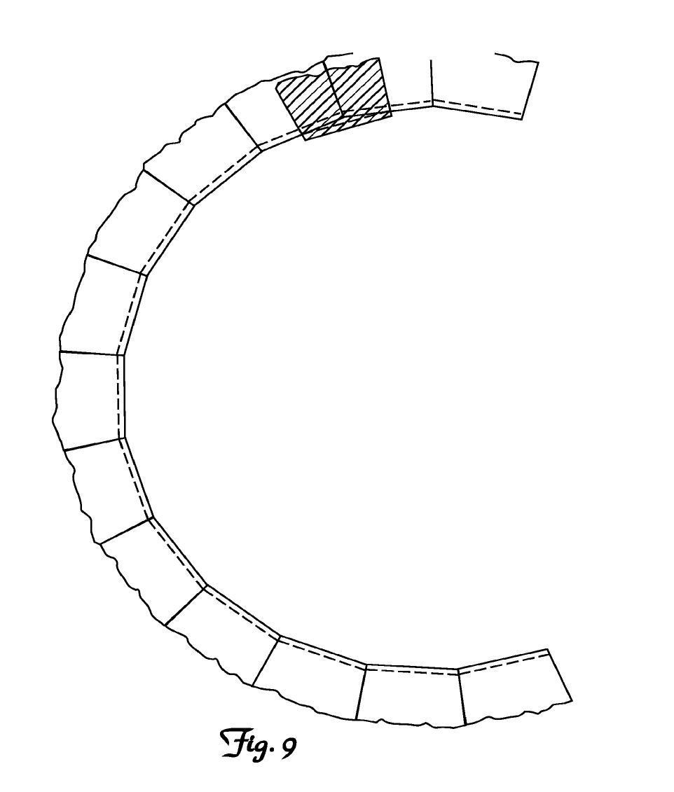

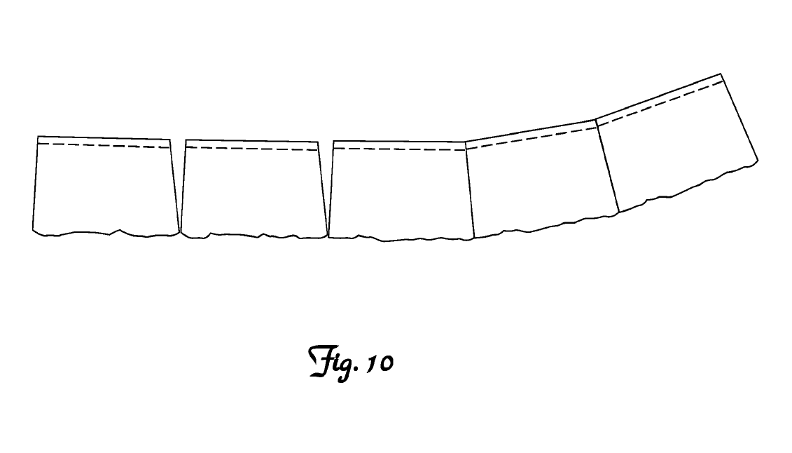

FIGS. 8, 9 and 10 are partial views of retaining walls constructed with the retaining wall blocks 10 of the present invention. FIG. 8 shows a first course of blocks formed in a concave curve. One block in an upper course of the wall is shown in crosshatch to illustrate how the rear lip or flange of the upper course connects to the back top edge of blocks in the lower course to provide both a setback of the blocks in the upper course and a means of securing the upper course to the lower course. The blocks are shown in forming a wall having a radius of approximately 3 foot 4 inches. In FIG. 9 the blocks of the present invention are used to construct a portion of a convex retaining wall. One block in the upper course shown in crosshatch is illustrated to show how the rear lip or flange of the block in the upper course connects to the back top edge of the top surface in blocks of the lower course. If blocks having a width of 12 inches and an angle α of 15 degrees are used to form the wall of FIG. 9, the wall can be constructed with a radius of 3 foot 4 inches without any gaps between the side surfaces of blocks of the courses. FIG. 10 shows construction of a portion of a retaining wall having a straight section and a curved section.

FIG. 11 is a side sectional view of a retaining wall formed with blocks according to a further embodiment of the present invention. Blocks 200 are similar to blocks 10 except a flange receiving channel 202 is formed into the rear portion of the top surface and the upper portion of the back face. As shown, the flange receiving channel of blocks in lower courses in the wall receives a portion of a flange from a block in an upper course. This configuration allows the flanges of the blocks to be made wider without increasing the amount of setback between courses of blocks in the wall. Blocks 200 may be formed in a mold box similar to mold box 50 or mold box 100 in which the mold cavities have been modified to include a vertically extending channel forming surface from the top of the mold cavity to the bottom of the mold cavity positioned opposite the vertical flange forming channel.

FIG. 11 also shows different core configurations which may be formed into blocks 200. It should be understood that the same core configurations and other alternatives thereto could be formed in any of the blocks disclosed herein. For example, the core may comprise a single rectangular void as shown in the top block of the wall of FIG. 11. Alternatively, the core may comprise two rectangular voids separated by a vertical support web as shown in the next lower course of blocks. A further alternative is three round cores divided by vertical support webs as shown in the next lower course of blocks. The provision of cores in the blocks is advantageous for a number of reasons. First, less material is used in forming the blocks making them less costly to produce. Second, the blocks which are formed are lighter than blocks without cores. This is advantageous since it makes the blocks easier to handle both in the production and shipping stages and also when retaining walls are constructed using the blocks. Third, walls formed from blocks having horizontally extending cores between side surfaces may be reinforced with horizontal reinforcement members such as rods or rebar. As the wall is constructed the cores in each block of a course of blocks align horizontally to form a horizontal conduit or pathway sized to accept reinforcement members of a desired length. Such horizontal reinforcement increases the strength and stability of the wall.

FIG. 12 shows a portion of a retaining wall formed with blocks of the present invention. The wall includes rectangular corner blocks 72 having a textured surface formed on both the front face of the block and one of the adjacent side walls and wall blocks 10 having an angled side surface. Depending on the application and the size of the blocks being used in the formation of the wall an optional score line may be imprinted on the top or bottom surface of the corner block during the molding process to allow the corner block to be split and create two corner forming units which can be placed in an L-shaped formation at the corner. Although not shown, this L-shape formation is beneficial to help maintain the blocks in a running bond pattern between the blocks of a lower course and blocks of an upper course

Although particular embodiments have been disclosed herein in detail, this has been done for purposes of illustration only, and is not intended to be limiting with respect to the scope of the claims. In particular, it is contemplated that various substitutions, alterations, and modifications may be made to the invention without departing from the spirit and scope of the invention as defined by the claims. For instance, the choice of materials or variations in the shape or angles at which some of the surfaces intersect are believed to be a matter of routine for a person of ordinary skill in the art with knowledge of the embodiments disclosed herein.

What is claimed is:

1. A mold assembly for use in producing retaining wall blocks comprising:
a horizontal planar bottom member;
a compression head; and
a mold box having a plurality of side walls that define a plurality of mold cavities having open mold cavity tops and open mold cavity bottoms, the horizontal planar member enclosing the open mold cavity bottoms of the plurality of mold cavities and the compression head enclosing the open mold cavity tops of the plurality of mold cavities during a block forming process, each of the plurality of mold cavities being shaped to form a single retaining wall block, each retaining wall block having opposed front and rear faces, opposed and substantially parallel top and bottom surfaces, and opposed first and second side surfaces, each of the plurality of mold cavities being oriented such that the first side surface of the retaining wall block is formed at the bottom of the mold cavity and the second side surface of the retaining wall block is formed by the compression head at the top of the mold cavity, the second side surface of at least one of the retaining wall blocks formed in at least one of the plurality of mold cavities being non-orthogonal to the front and rear faces of the retaining wall block and non-parallel to the first side surface of the retaining wall block, one of the side walls of each of the plurality of mold cavities being moveable from an inward block forming position to a retracted discharge position, the moveable sidewall having a three dimensional surface texture or pattern that imparts to the front face of the retaining wall block a three dimensional surface texture or pattern during the block forming process, at least one of the plurality of mold cavities having a flange forming channel, each flange forming channel being formed entirely from planar surfaces of the side walls of the mold cavity that are perpendicular to the horizontal planar bottom member such that the flange forming channel extends from the open mold cavity top to the open mold cavity bottom and provides at least one of the retaining wall blocks formed in at least one of the plurality of mold cavities with a flange extending from the rear face downward past the bottom surface of the retaining wall block;
wherein at least one of the plurality of mold cavities has at least one core forming member which extends vertically into the mold cavity to provide the retaining wall block formed therein with a core extending from the second side surface to the first side surface.

2. The mold assembly of claim 1 wherein the at least one core forming member is at least two core forming members configured to form at least two cores extending from the second side surface to the first side surface of the retaining wall block.

3. The mold assembly of claim 1 wherein the at least one core forming member is configured to form a core having a shape selected from round, oval, rectangular and square.

4. The mold assembly of claim 1 wherein the compression head includes a lower surface which encloses the open mold cavity tops, the lower surface being angled at an angle α with respect to horizontal such that the second side surface of the retaining wall block formed in each of the plurality of mold cavities during the block forming process forms angle α with respect to the front face of the retaining wall block, and wherein angle α is between about 5° to 20°.

5. The mold assembly of claim 4 wherein angle α is between about 7½° to 15°.

6. The mold assembly of claim 1 wherein at least one of the plurality of mold cavities has a ridge forming projection, each ridge forming projection being formed entirely from planar surfaces of the side walls of the mold cavity that are perpendicular to the horizontal planar bottom member and provide the retaining wall block formed therein with a flange receiving channel formed into a rear portion of the top surface and an upper portion of the rear face of the retaining wall block.

7. The mold assembly of claim 1 wherein at least one of the plurality of mold cavities has at least one core forming member which extends vertically into the mold cavity from at least one core bar that spans from one side wall to an opposed side wall of the mold cavity, the core bar having an upper surface and a lower surface, the lower surface having a slope that angularly descends into the mold cavity from one side wall to the opposed side wall.

8. The mold assembly of claim 7 wherein the lower surface of the at least one core bar forms a portion of the surface of the second side wall of the retaining wall block formed in the mold cavity.

9. A mold assembly for use in producing retaining wall blocks of a first type and wall blocks of a second type comprising:
a horizontal planar bottom member;
a compression head;
a mold box having a plurality of side walls that define a plurality of mold cavities having open mold cavity tops and open mold cavity bottoms, at least one of the plurality of mold cavities being configured to form the first type block and the remainder of the mold cavities being configured to form the second type block, the horizontal planar member enclosing the open mold cavity bottoms of the plurality of mold cavities and the compression head having one or more horizontal lower surfaces for enclosing the open mold cavity top of the at least one mold cavity configured to form the first type block and the compression head having one or more angled lower surfaces for enclosing the open mold tops of the remainder of the plurality of mold cavities used to form the second type block during a block forming process, each of the plurality of mold cavities being shaped to form a single retaining wall block, each of the first and second block types having opposed front and rear faces, opposed and substantially parallel top and bottom surfaces, and opposed first and second side surfaces, each of the plurality of mold cavities being oriented such that the first side surface of each of the first and second block types are formed at the bottom of the mold cavity and the second side surface of each of the first and second type blocks are formed by the compression head at the top of the mold cavity, the second side surface of at least the second type blocks being non-orthogonal to the front and rear faces of the second type blocks and non-parallel to the first side surface of the second type blocks, one of the side walls of each of the plurality of mold cavities being moveable from an inward block forming position to a retracted discharge position, the moveable sidewall having a three dimensional surface texture or pattern that imparts to the front face of the retaining wall block a three dimensional surface texture or pattern during the block forming process, at least one of the plurality of mold cavities having a flange forming channel, each flange forming channel being formed entirely from planar surfaces of the side walls of the mold cavity that are perpendicular to the horizontal planar bottom member such that the flange forming channel extends from the open mold cavity top to the open mold cavity bottom and provides the retaining wall block formed in the at least one of the plurality of mold cavities with a flange extending from the rear face downward past the bottom surface of the retaining wall block; and
at least one core forming member which extends vertically into at least one of the plurality of mold cavities used to form the retaining wall block to provide the retaining wall block formed therein with a core extending from the first side surface to the second side surface.

10. The mold assembly of claim 9 wherein the one or more horizontal surfaces of the compression head have a three dimensional surface texture or pattern that imparts to the second side wall of the first type block a three dimensional surface texture or pattern during the block forming process.

11. The mold assembly of claim 9 wherein the at least one core forming member is at least two core forming members configured to form at least two cores extending from the second side surface to the first side surface of the retaining wall block.

12. The mold assembly of claim 9 wherein at least one of the plurality of mold cavities has a ridge forming projection, each ridge forming projection being formed entirely from planar surfaces of the side walls of the mold cavity that are perpendicular to the horizontal planar bottom member and provide the retaining wall block formed therein with a flange receiving channel formed into a rear portion of the top surface and an upper portion of the rear face of the retaining wall block.

13. The mold assembly of claim 9 wherein the at least one core forming member extends vertically into at least one of the plurality of mold cavities from at least one core bar that spans from one side wall to an opposed side wall of the mold cavity, the core bar having an upper surface and a lower surface, the lower surface having a slope that angularly descends into the mold cavity from one side wall to the opposed side wall.

14. The mold assembly of claim 13 wherein the lower surface of the at least one core bar forms a portion of the surface of the second side wall of the retaining wall block formed in the mold cavity.

15. A method of making a plurality of retaining wall blocks comprising:
providing a mold assembly including a pallet, a compression head, a mold box having a plurality of side walls that define a plurality of mold cavities having open mold cavity tops and open mold cavity bottoms, and at least one core forming member that extends vertically into at least one of the plurality of mold cavities from the mold cavity top to the mold cavity bottom, each of the plurality of mold cavities being shaped to form a single retaining wall block, each retaining wall block having opposed front and rear faces, opposed and substantially parallel top and bottom surfaces, opposed first and second side surfaces, at least one of the retaining wall blocks having a flange extending from the rear face downward past the bottom surface, and at least one of the retaining wall blocks having a core that extends between the first and second side surfaces, each of the plurality of mold cavities being oriented such that the first side surface is formed at the bottom of the mold cavity and the second side surface is formed at the top of the mold cavity, the second side surface of at least one of the retaining wall blocks formed in at least one of the plurality of mold cavities being non-orthogonal to the front and rear faces of the retaining wall block and non-parallel to the first side surface of the retaining wall block, at least one of the plurality of mold cavities having a flange forming channel, each flange forming channel being formed entirely from planar surfaces of the side walls of the mold cavity that are perpendicular to the horizontal planar bottom member such that the flange forming channel extends from the open mold cavity top to the open mold cavity bottom and provides the retaining wall block formed therein with a flange extending from the rear face downward past the bottom surface of the retaining wall block, one of the side walls of each of the plurality of mold cavities being moveable from an inward block forming position to a retracted discharge position, the moveable side walls having a three dimensional surface texture or pattern;
positioning the pallet beneath the mold box to enclose the mold cavity bottoms;
filling the mold cavities with dry cast concrete while the moveable side walls are in the inward block forming position;
lowering the compression head to enclose the open mold cavity tops and compress the dry cast concrete within the plurality of mold cavities;
moving the moveable side walls from the inward block forming position to the retracted discharge position; and
lowering the pallet and the compression head to strip the dry cast concrete from the plurality of mold cavities.

16. The method of claim 15 wherein the at least one core forming member is at least two core forming members configured to form at least two cores extending from the second side surface to the first side surface of the retaining wall block.

17. The method of claim 15 wherein the compression head includes a lower surface which encloses the open mold cavity tops, the lower surface being angled at an angle α with respect to horizontal such that the second side surface of the retaining wall block formed in each of the plurality of mold cavities during the block forming process forms angle α with respect to the front face of the retaining wall block, and wherein angle α is between about 5° to 20°.

18. The mold assembly of claim 15 wherein at least one of the plurality of mold cavities has a ridge forming projection, each ridge forming projection being formed entirely from planar surfaces of the side walls of the mold cavity that are perpendicular to the horizontal planar bottom member and provide the retaining wall block formed therein with a flange receiving channel formed into a rear portion of the top surface and an upper portion of the rear face of the retaining wall block.

19. The mold assembly of claim 15 wherein the at least one core forming member extends vertically into at least one of the plurality of mold cavities from at least one core bar that spans from one side wall to an opposed side wall of the mold cavity, the core bar having an upper surface and a lower surface, the lower surface having a slope that angularly descends into the mold cavity from one side wall to the opposed side wall.

20. The mold assembly of claim 19 wherein the lower surface of the at least one core bar forms a portion of the surface of the second side wall of the retaining wall block formed in the mold cavity.
